(19) United States
(12) Patent Application Publication
(10) Pub. No.: US 2017/0008303 A1
(43) Pub. Date: Jan. 12, 2017

(54) METHOD AND DEVICE FOR PRODUCING A DIRECTLY PRINTED DECORATIVE PANEL TO REDUCE MISPRINTS DUE TO PRINTING ERRORS

(71) Applicant: AKZENTA PANEELE + PROFILE GMBH, Kaisersesch (DE)

(72) Inventor: Arne LOEBEL, Düsseldorf (DE)

(21) Appl. No.: 15/113,647

(22) PCT Filed: Dec. 8, 2014
(86) PCT No.: PCT/EP2014/076860

§ 371 Date: Jul. 22, 2016

(30) Foreign Application Priority Data
Jan. 27, 2014 (DE) 10 2014 100 858.8

(51) Int. Cl. B41J 3/407; E04F 15/10; E04F 13/08; B41J 2/01

(52) U.S. Cl. CPC B41J 3/407; B41J 2/01; E04F 15/10; E04F 13/0871

(57) ABSTRACT

The disclosure relates to a method for producing a directly printed decorative panel while reducing waste due to printing errors. Moreover, the disclosure relates to a device for producing a decorative panel which is able to detect a printing defect in a decorative image applied onto a carrier plate by means of direct printing and to sort out the decorative panel in which the printing defect occurs.

### CROSS-REFERENCE TO RELATED APPLICATIONS

This application is a National Stage of International Application No. PCT/EP2014/076860, filed on Dec. 8, 2014, and published in German as WO 2015/110213 A1 on Jul. 30, 2015. This application claims the priority to German Application No. 10 2014 100 858.8, filed on Jan. 27, 2014. The entire disclosures of the above applications are incorporated herein by reference.

### FIELD

The present disclosure relates to a method for producing a directly printed decorative panel while reducing waste due to printing errors. Moreover, the present disclosure relates to a device for producing a decorative panel which is adapted to detect a defect in a decorative image applied onto a carrier plate by means of direct printing and to sort out the decorative panel which includes the defect.

### BACKGROUND

This section provides background information related to the present disclosure which is not necessarily prior art.

The term decorative panel in the sense of the disclosure means wall, ceiling or floor panels comprising a decoration applied onto a carrier plate. Decorative panels are used in a variety of ways both in the field of interior design of rooms and for decorative cladding of buildings, for example in exhibition stand construction. One of the most common application fields of decorative panels is their use as a floor covering. Herein, the decorative panels often comprise a decoration intended to replicate a natural material.

Examples of such replicated natural materials are wood species such as maple, oak, birch, cherry, ash, walnut, chestnut, wenge or even exotic woods such as Panga Panga, mahogany, bamboo and bubinga. In addition, often natural materials such as stone surfaces or ceramic surfaces are replicated.

Heretofore, such decorative panels are often produced as laminates in which a decorative paper preprinted with a desired decoration is applied onto a carrier plate and, in turn, a so-called overlay is applied onto the decorative paper. In order to avoid a deformation of the decorative panels, the so-called cupping, by shrinkage effects of the applied decorative paper subsequently a backing paper is applied on the side of the carrier plate opposite to the decorative paper and the layered structure obtained is fixedly bonded together by use of appropriate pressure and/or heat-activated adhesives. The forces acting on the carrier plate by the backing paper thereby should counteract the tensile forces caused by the cupping.

Dependent on the desired area of application of the decorative panels they can be made of different materials. In particular, the material of the carrier can be chosen depending on the area of application. Thus, the carrier may for example consist of a wood-based material, provided that the decorative panels are not exposed to excessive moisture or weather conditions. If, on the other hand, the panel is to be used for example in wet rooms or outdoors the carrier may, for example, consist of a plastic material.

Wood-based materials in the sense of the disclosure in addition to solid wood materials are materials such as cross-laminated timber, glue-laminated timber, blockboard, veneered plywood, laminated veneer lumber, parallel strand lumber and bending plywood. In addition, wood-based materials in the sense of the disclosure are also chipboards such as pressboards, extruded boards, oriented structural boards (OSB) and laminated strand lumber as well as wood fiber materials such as wood fiber insulation boards (HFD), medium hard and hard fiberboards (MB, HFH) and in particular medium density fiberboards (MDF) and high density fiberboards (HDF). Even modern wood-based materials such as wood polymer materials (wood plastic composite, WPC)—in particular WBC based on thermoplastics such as PVC—sandwich boards made of a lightweight core material such as foam, rigid foam or honeycomb paper and a layer of wood applied thereto, and minerally hardened, for example with cement, chipboards are wood-based materials in the sense of the disclosure. Moreover, cork represents a wood-based material in the sense of the disclosure.

Plastic materials which can be used for producing corresponding panels are, for example, thermoplastic plastic materials such as polyvinyl chloride (PVC), polyolefines (such as polyethylene (PE), polypropylene (PP)), polyamides (PA), polyurethanes (PU), polystyrene (PS), acrylonitril butadiene styrene (ABS), polymethyl methacrylate (PMMA), polycarbonate (PC), polyethylene terephthalate (PET), polyether ether ketone (PEEK) or mixtures or co-polymerizates thereof. The plastic materials can include common fillers, such as calcium carbonate (chalk), aluminum oxide, silica gel, quartz powder, wood flour, gypsum. In addition they can be coloured in a known way.

In the sense of the disclosure the term fiber materials means materials such as paper and non-woven fabrics on the basis of plant, animal, mineral or even synthetic fibers as well as cardboards. Examples are fiber materials on the basis of plant fibers and, in addition to papers and non-woven fabrics made of cellulose fibers, boards made of biomass such as straw, maize straw, bamboo, leaves, algae extracts, hemp, cotton or oil palm fibers. Examples of animal fiber materials are keratin-based materials such as wool or horsehair. Examples of mineral fiber materials are mineral wool or glass wool.

For protecting the applied decorative layer normally wearing or top layers are applied on top of the decorative layer. A wearing and/or top layer in the sense of the disclosure is a layer applied as an outer border which in particular protects the decorative layer from wear or damage caused by dirt, moisture and mechanical impacts such as abrasion. The wearing and/or top layers used in the prior art frequently also exert a pulling effect on the carrier plate, which has to be compensated by a corresponding design of the backing layer, in order to avoid the previously mentioned cupping of the decorative panel.

It is often intended to introduce a surface structure matching with the decoration in such a wearing or top layer. A surface structure matching with the decoration means that the surface of the decorative panel has a haptically perceivable structure which with respect to its shape and pattern corresponds to the applied decoration in order to achieve a reproduction of a natural material as close to the original as possible even with respect to the haptic.

A problem which may occur during direct printing of decorative panels is that the surface of the decorative panel to be printed is no optimal printing substrate onto which a corresponding decoration can be applied. Here, the problem is that a paper or non-woven fabric layer applied as a printing substrate onto a carrier plate of a decorative panel is penetrated by the resin used for the application such that the resin applied for fixing penetrates through on the side of the paper or non-woven fabric intended to be printed and can cause adhesion problems of the printing ink there. To overcome this problem, the paper or non-woven fabric may be provided with a barrier layer that prevents the penetration of the resin through the paper or non-woven fabric. However, such a barrier layer often brings about that the ink applied in the printing process does not or not sufficiently settle into the paper or non-woven fabric, but remains on the surface, which adversely affects the quality of the print. Furthermore, it can be provided that the paper or non-woven fabric is provided with an ink receiving layer on the side to be printed prior to the application onto the carrier plate, and then the ink receiving layer is printed. The decorative paper thus prepared is then applied onto the carrier plate. However, during the subsequent application of a top or wearing layer adhesion problems can be caused, so that the final composite laminate has no sufficient stability and, for example, splitting of the laminate in the decorative paper layer is caused.

The term “direct printing” in the sense of the disclosure means the application of a decoration directly onto the carrier of a panel or onto an unprinted fiber material layer applied to the carrier. In contrast to the conventional methods in which a decorative layer previously printed with a desired decoration is applied onto the carrier, in direct printing the decoration is printed directly in the course of the surface coating or the panel manufacturing process. Here, different printing techniques such as flexographic printing, offset printing or screen printing may be used. In particular digital printing techniques such as inkjet processes or laser printing can be used.

During the production of a decorative panel by direct printing processes defects in the printed image may arise, i.e. deviations between the decorative image applied by direct printing and the corresponding decorative image template. Such defects can occur, for example, by irregularities in the inking unit of a printing device, such as a flexographic printing, offset printing or screen printing device. In the use of inkjet processes for example malfunctions or failures of individual ink nozzles or complete printheads may occur. In the case of laser printing processes both defects on the transfer drum and failures in the toner applicators can cause defects in the printed image.

In the manufacture of decorative panels usually a large-sized carrier plate having a surface corresponding to a multiple of the surface of the later decorative panel is provided with a decoration which is subsequently protected from wear by applying a corresponding wear-resistant coating in the form of an overlay or a top layer. The decorated large-sized carrier plate thus produced is then divided into individual decorative panels, for example by means of a sawing or cutting device, and the individual panels are optionally provided with a profile in the edge region.

If now printing defects occur during the application of the decorative image onto the carrier plate, for example due to failures in the printing device, normally the complete large-sized carrier plate is sorted out and discarded. This leads to large waste even of areas without defects of the decorative image applied onto the large-sized carrier plate.

### SUMMARY

This section provides a general summary of the disclosure, and is not a comprehensive disclosure of its full scope or all of its features.

It is the object of the present disclosure to provide a method and a device for producing a directly printed decorative panel by means of which the material waste can be reduced during the manufacturing process.

Thus, according to the disclosure a method for producing a decorative panel is proposed, comprising at least the following steps:
a) providing a plate-shaped carrier having a surface corresponding to a multiple of the surface of the decorative panel to be produced;
b) applying a decoration onto the plate-shaped carrier by means of a direct printing process;
c) detecting printing defects in the applied decoration;
d) marking the area of the detected printing defects by means of a marking agent;
e) dividing the plate-shaped carrier provided with the decoration into panels;
f) detecting any marking agent applied in step d); and
g) sorting the panels depending on the presence of a marking agent on the panel.

It has been shown that by applying a marking agent in the area of detected printing defects a simple detection of decorative panels is possible which have a corresponding defective decorative image area and to surely distinguish them from decorative panels which are free of printing defects. Because of this distinction it is possible to sort out only those decorative panels which actually have a defective decorative image reproduction and thus to reduce the amount of waste considerably.

According to a preferred embodiment of the disclosure the decorative image is applied onto the carrier plate or onto a printing substrate disposed on the carrier plate by means of a digital printing process.

Methods and devices for automatic pattern recognition are known by means of which even large-sized patterns can be examined with respect to possible defects. These processes operate with a sufficient reliability even with complex patterns. Typically the pattern applied to a large-sized carrier plate comprises as few pattern repetitions as possible in order to obtain the smallest possible number of panels with identical decorative images when the large-sized plate is divided into decorative panels. In this way the natural impression is enhanced, since in nature, too, for example, in wood grains often used as a template, an exact repetition of patterns and structures occurs rarely. A detection of defects in the decorative image of the individual decorative panels, however, is very complex due to the small number of pattern repetitions, since a large number of individual patterns should have to be stored, which have to be compared with the corresponding decorative panel. Also, the very high material flow rate leads to further problems in the detection of defects in the usual production process.

By means of the application of a marking agent in the area of the printing defect a panel which has a printing defect in the decorative image can be detected by means of the applied marking agent in the further production process. This depending on the marking agent is possible with simple optical or other detection methods.

In one embodiment of the disclosure it can be provided that the marking agent is applied to the decoration side and/or the back side of the large-sized carrier plate and, thus, can ultimately be found on the decoration side and/or the back side of the decorative panel.

Herein, it may be provided, for example, that as a marking agent a colored marking is applied which is distinctly different from the color of the decorative image, such as a fluorescent dye, which can be recognized without pattern recognition already because of its uniqueness of color. This is particularly advantageous if the marking agent is applied onto the decorative side of the carrier plate.

In one embodiment of the disclosure it may be provided that as marking agents a fluorescent ink is applied and a UV-light source and a photocell are used as a detection means for detecting the marking agent. If a decorative panel comprises a corresponding fluorescent marking, it will be excited by the irradiated UV-radiation and emits corresponding light, which in turn can be detected by the photocell. Depending on the detection of the emitted light then a decorative panel can be sorted out, while other decorative panels without printing defects, which were taken from the same large-sized carrier plate as the panel with printing defects, have no fluorescent marking and accordingly need not to be sorted out.

Preferably, a radiation curable paint and/or ink is used for the application of the marking agent. Radiation-curable in the sense of the disclosure means that the paint and/or ink is cured by electromagnetic radiation, such as UV radiation or electron radiation. Herein, it may be in particular provided that the paint and/or ink includes appropriate radiation or photo-induced polymerizing components. Examples of appropriate components are acrylates, epoxides or cyclic amines such as ethyleneimine.

If the marking agent is applied onto the back side of the carrier plate, which preferably has no decorative image, a contrasting paint, for example, is appropriate as a marking agent in order to ensure the recognition of decorative panels, which have printing defects in their decorative image. Thus, it can be provided, for example, to apply a dark paint as a marking agent in case of a bright back side of the carrier plate or to apply a corresponding bright paint in case of a dark back side. Such a marking then can be detected using a simple light/dark detection.

The advantage of a visually perceptible marking agent is that the large-sized carrier plate can continue to pass the normal manufacturing process, in which a wear-resistant coating is applied after the application of the decorative image. Since this is transparent to keep the underlying decorative image visible for the user, it is also optically transparent for the marking agent.

According to a further embodiment of the disclosure it can be provided that as the marking agent an electrically conductive substance or a substance which after its application onto a surface forms an electrically conductive surface is applied. For the detection of decorative panels which comprise printing defects in the decorative image then a conductivity measurement of the surface or between measuring points on the surface can be implemented. This is useful especially if the marking agent is applied onto the back side of the large-sized carrier plate, which normally is not subsequently sealed by a wear-resistant coating.

The application of the marking agent according to the disclosure may for example be done by means of spray coating, brush coating or roller coating.

With respect to the device the object of the disclosure is achieved by means of a device for producing a decorative panel comprising a supply means for supplying a plate-shaped carrier to a direct printing means which is adapted to apply a decorative image onto the plate-shaped carrier, a detection means for detecting a printing defect in said decorative image applied by means of the direct printing means, a marking means for applying marking agents onto the plate-shaped carrier and a control means, wherein the detection means and the marking means are connected to the control means such that upon detection of a printing defect in the decorative image applied by use of the direct printing means, a control signal can be output from the control means to the marking means which causes the marking means to apply a marking agent onto the plate-shaped carrier in the area of the detected printing defect.

Herein, the detection means for detecting a printing defect can, for example, consist of a camera system with a corresponding pattern recognition software that visually recognizes the printed image applied by the direct printing means and compares it with a digitally stored reference pattern.

The marking means in accordance with one embodiment of the disclosure may, for example, be a means for applying a paint, such as a paint spraying head, a roller or a brush paint coating system. Herein, it may be provided in accordance with one embodiment of the disclosure that the marking means comprises a plurality of paint application systems arranged side-by-side which are activated depending on the position of the detected printing defect and thus apply a corresponding marking agent in the area of the printing defect.

To this end it may, for example, be provided that the digitally stored reference pattern is stored as a rastered image in a control system and the paint application systems are associated with grid points of the reference image. Then, depending on the grid points in which the printing defect occurs the associated paint application system is activated.

In a further embodiment it may be provided that the marking means comprises a paint application system movable on a tangential arm, wherein the paint application system is moved by means of the tangential arm into the area of the detected printing defect, and after reaching this area allows for a corresponding application of the marking means. Herein, it may be also provided that an appropriate marking means comprises a plurality of paint application systems, which are arranged on a common tangential arm or on separate tangential arms.

According to another embodiment of the disclosure it may be preferably provided that the device comprises means for dividing the plate-shaped carrier into individual decorative panels. Such a means can be designed, for example, as a sawing and/or cutting means. In addition to machining means according to the disclosure depending on the selected material of the carrier plate water-jet or laser cutting means may be provided, too.

Furthermore, in one embodiment the device according to the disclosure may comprise a detection means for detecting marking agents applied onto the decorative panels, a sorting means for sorting decorative panels, and a control means, wherein the detection means and the sorting means are connected to the control means such that a control signal can be output from the control means to the sorting means which causes the sorting means to sort the decorative panels depending on marking means applied thereto.

The detection means for detecting marking agents applied onto the decorative panels may include, for example an optical sensor, such as a camera or a photocell, which is adapted to detect applied visually perceptible marking agents and to output a signal as a function of their occurrence.

In an alternative embodiment it can be provided that as a marking agent electrically conductive substances and/or substances, which cause an electrical conductivity of the surface on which they were applied, are applied and the detection means comprises means for determining the conductivity on a surface of decorative panel. Such means may, for example, be formed by a series of measuring electrodes spaced apart from each other, between which the occurrence of a change in conductivity can be measured.

In addition, the disclosure proposes a decorative panel comprising a carrier and a decorative image applied on this carrier by means of a direct printing process, wherein the decorative panel comprises a marking agent in an area where the applied decorative image deviates from of a template of the decorative image.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Hereinafter embodiments of the disclosure will be explained in detail with reference to figures. In the figures:

FIG. 1 shows a system including a direct printing means and downstream detecting and marking means; and

FIG. 2 shows a system including a dividing means, a detection means and a sorting means.

Corresponding reference numerals indicate corresponding parts throughout the several views of the drawings.

### DETAILED DESCRIPTION

Example embodiments will now be described more fully with reference to the accompanying drawings.

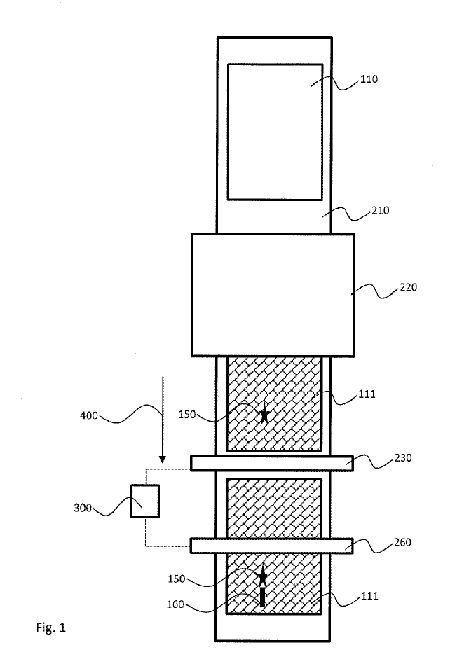

FIG. 1 shows a device for producing a decorative panel comprising a supply means 210 for supplying a plate-shaped carrier 110 to a direct printing means 220. The direct printing means 220 may be, for example, an inkjet printing system, which is adapted to apply a decorative image onto the plate-shaped carrier 110. Downstream in the conveying direction 400 a detection means 230 for detecting a printing defect 150 in the decorative image applied by the direct printing means 220 is provided. Such a detection means may be, for example, a camera system, such as a line camera, and a corresponding analysis software, which is executed on a computer-aided control system 300. A marking means 260 for applying marking agents 160 onto the plate-shaped carrier 110 is disposed downstream of the detection means 230 in the conveying direction 400 and is connected to the control means 300 by signaling technology. Such a marking means may comprise, for example, an inkjet printhead by means of which, for example, a colored line is applied as a marking agent above and/or below the printing defect. The detection means 230 and the marking means 260 are connected in such a way to the control means 300 by signaling technology that upon detection of a printing defect 150 in the decorative image applied by means of the direct printing means 220 a control signal is output from the control means 300 to the marking means 260, which causes the marking means 260 to apply a marking agent 160 onto the plate-shaped carrier 110 in the area of the detected printing defect 150.

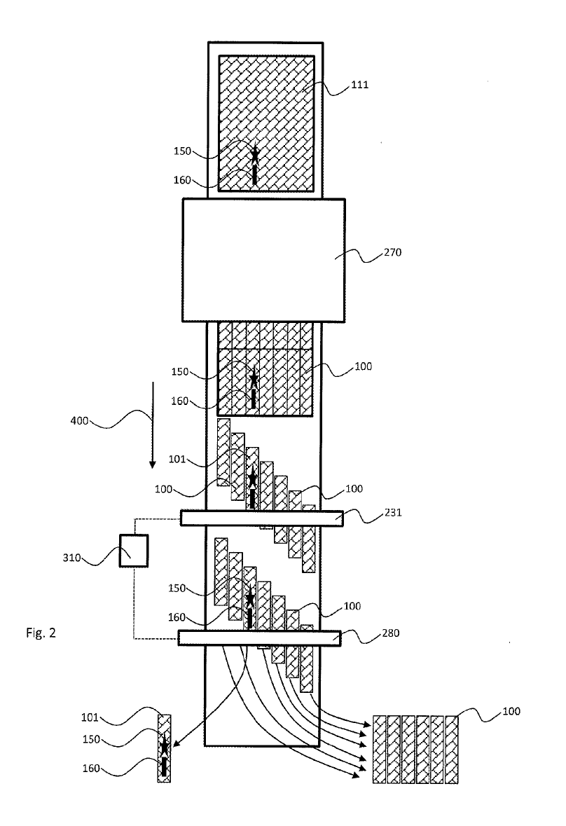

FIG. 2 shows a device which may be arranged downstream in the production flow of the device shown in FIG. 1 or forms an integrated device therewith. The device in this case comprises a means 270 for dividing the printed plate-shaped carrier 111 into individual decorative panels 100. Downstream of the means 270 in the conveying direction 400 a detection means 231 for detecting marking agents 160 applied to the decorative panels 100 is arranged which, for example, depending on the marking agent 160 may be configured as a camera system, a photocell or a conductivity measuring system and is connected to a computer-aided control means 310 by signaling technology. A sorting means 280 for sorting decorative panels 100 is provided which is also connected to the control means 310 by signaling technology. Herein, the detection means 231 and the sorting means 280 are connected to the control means 310 such that a control signal is output from the control means 310 to the sorting means 280 which causes the sorting means 280 to sort the decorative panels 100 depending on a marking agent 160 disposed thereon.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method for producing a decorative panel, at least comprising the steps of
a) providing a plate-shaped carrier having a surface corresponding to a multiple of the surface of the decorative panel to be produced;
b) applying a decoration onto the plate-shaped carrier by means of a direct printing process;
c) detecting printing defects in the applied decoration;
d) marking the area of the detected printing defects by means of a marking agent;
e) dividing the plate-shaped carrier provided with the decoration into panels;
f) detecting possible marking agents applied in step d); and
g) sorting the panels depending on the presence of a marking agent on the panel.

2. The method according to claim 1, wherein the decoration is applied by means of a digital printing process.

3. The method according to claim 1, wherein the marking agent is applied on the decorative side and/or the back side of the carrier plate.

4. The method according to claim 1, wherein the marking agent is an optical and/or electrically conductive marking agent.

5. A device for producing a decorative panel comprising a supply means for supplying a plate-shaped carrier to a direct printing means which is adapted to apply a decorative image onto the plate-shaped carrier, a detection means for detecting a printing defect in the decorative image applied by means of the direct printing means, a marking means for applying a marking agent onto the plate-shaped carrier and a control means, wherein the detection means and the marking means are connected to the control device such that upon detection of a printing defect in the decorative image applied by means of the direct printing means a control signal can be output from the control means to the marking means which causes the marking means to apply a marking agent onto the plate-shaped carrier in the area of the detected printing defect.

6. The device according to claim 5, wherein the device comprises a means for dividing a printed plate-shaped carrier into individual decorative panels.

7. The device according to claim 6, wherein said device comprises a detection means for detecting marking agents applied onto the decorative panels, a sorting means for sorting decorative panels and a control means, wherein the detection means and the sorting means are connected to the control device such that a control signal can be output from the control means to the sorting means which causes the sorting means to sort the decorative panels depending on marking agents applied thereon.

8. The device according to claim 5, wherein the direct printing means is a digital printing system.

9. The device according to claim 1, wherein the marking means is a means for applying an optical marking agent.

10. A decorative panel comprising a carrier and a decorative image applied onto the carrier by means of a direct printing process, wherein the decorative panel comprises a marking agent in an area in which the decorative image deviates from a template of the decorative image.

11. The device according to claim 6, wherein the direct printing means is a digital printing system.

12. The device according to claim 7, wherein the direct printing means is a digital printing system.
